(19) United States
(12) Patent Application Publication
(10) Pub. No.: US 2025/0350920 A1
(43) Pub. Date: Nov. 13, 2025

(54) METHOD AND SYSTEM TO SHARE UE MOBILITY CHARACTERISTICS IN 3GPP EDGE APPLICATIONS AND HTTP SERVICES

(71) Applicant: Samsung Electronics Co., Ltd., Suwon-si, Gyeonggi-do (KR)

(72) Inventors: Vijay SANGAMESHWARA, Bangalore (IN); Sapan Pramodkumar SHAH, Bangalore (IN); Basavaraj Jayawant PATTAN, Bangalore (IN)

(21) Appl. No.: 18/854,419

(22) PCT Filed: Apr. 5, 2023
(86) PCT No.: PCT/KR2023/004568

§ 371 Date: Oct. 4, 2024

(30) Foreign Application Priority Data
Apr. 5, 2022 (IN) 202241020595
Feb. 21, 2023 (IN) 202241020595

(51) Int. Cl. H04W 8/10; H04W 60/04; H04W 64/00

(52) U.S. Cl. CPC H04W 8/10; H04W 60/04; H04W 64/00

(57) ABSTRACT

The disclosure relates to a 5G or 6G communication system for supporting a higher data transmission rate. Embodiments herein provide a method to share UE mobility characteristics in an edge network (1000) by an EES (200). The method includes receiving an EEC registration request message comprising a mobility indication from an EEC device (1000). Further, the method includes determining whether the mobility indication indicates whether the EEC device supports mobility. Further, the method includes performing subscribing to a 3GPP core network entity for UE location information when the mobility indication indicates that the EEC device supports mobility, storing the location information in an EEC context, and sending an EEC registration response message to the EEC device. In another embodiment, the method includes performing one-time location fetch for the EEC when the mobility indication indicates that the EEC device does not support mobility, storing the location information in a memory of the EES, and sending an EEC registration response message to the EEC device.

### TECHNICAL FIELD

The present disclosure relates to a wireless communication and systems, and more particularly to a method and system to share mobility characteristics of a User Equipment (UE) in 3^{rd} Generation Partnership Project (3GPP) Edge Applications and Hypertext Transfer Protocol (HTTP) based Service.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and apolar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

To provide smooth service continuity during handovers between an Edge Data Network (EDN) caused due to User Equipment's (UEs) mobility behaviour, an Edge Enabler Server (EES) in the EDN shall continuously track a UE location by performing SUBSCRIBE for both UE location and location analytics (for UE future location predictions) anticipating a possibility of handover request from the UE.

In an EDGE application, currently there is no method to determine the mobility characteristics of the UE at the EDN unless explicit fetch/subscribe for location is performed by the EES. In absence of the mobility characteristics at the EDN, unnecessary and continuous tracking of even UEs with fixed (stationary) mobility behaviour is performed through SUBSCRIBE where in these UE shall be fixed in particular location (always stay under the same mobile network serving area) and never cause handovers.

Thus, it is desired to address the above-mentioned disadvantages or other shortcomings or at least provide a useful alternative.

### DISCLOSURE OF INVENTION

### Technical Problem

The purpose of this application is to be able to solve at least one of the drawbacks of the prior art.

The principal object of the embodiments herein is to provide a method and system to share mobility characteristics of User Equipment (UE) in 3rd Generation Partnership Project (3GPP) Edge Applications and Hypertext Transfer Protocol (HTTP) based Service.

Another object of the embodiments herein is to provide a method for an EEC residing on the UE to share mobility behaviour to an EES within an edge network.

Another object of the embodiments herein is to provide a method for EEC to encode the mobility behaviour in the EEC registration request sent towards EES within the edge network.

Another object of the embodiments herein is to provide a method for an EES within the edge network to decode a mobility behaviour received in an EEC registration request from the EEC device.

Another object of the embodiments herein is to provide an HTTP header that shall be used by HTTP based application to share mobility behaviour of UE and other UE characteristics (like so-called constrained devices as defined in section 3 of RFC 7228) with its authorized network entities.

### Solution to Problem

Accordingly, the embodiment herein is to provide a method to share User Equipment (UE) mobility characteristics in an edge network. The method includes receiving, by an Edge Enabler Server (EES) in the edge network, an Edge Enabler Client (EEC) registration request message comprising a mobility indication from an EEC device in the edge network. Further, the method includes determining, by the EES, whether the mobility indication indicates whether the EEC device supports mobility. Further, the method includes performing, by the EES, subscribe to an 3rd Generation Partnership Project (3GPP) core network entity for UE location information and UE location analytics information, when the mobility indication indicates that the EEC device supports mobility, storing the location information in a EEC context, and sending a EEC registration response message to the EEC device. Further, the method includes performing one-time location fetch for the EEC when the mobility indication indicates that the EEC device does not support mobility, storing the location information in a memory of the EES, and sending an EEC registration response message to the EEC device.

In an embodiment, the method includes receiving, by the EES, an EEC registration update request message comprising a mobility indication from the EEC device. Further, the method includes determining, by the EES, whether the mobility indication indicates the EEC device supports mobility. Further, the method includes performing, by the EES, subscribe to a 3GPP core network entity for UE location information and UE location analytics information, when the mobility indication indicates that the EEC device supports mobility, storing the location information in the EEC context, and sending an EEC update registration response message to the EEC device. Further, the method includes performing one-time location fetch for the EEC when the mobility support indication indicates that the EEC device does not support mobility, storing the location information in the memory of the EES, and sending an EEC update registration response message to the EEC device.

Accordingly, the embodiment herein is to provide an EES to receive UE mobility characteristics in an edge network. The EES includes a UE mobility characteristics controller connected to a memory and a processor. The UE mobility characteristics controller is configured to receive an “EEC registration request message” or “EEC update registration request message” comprising a mobility support indication from an EEC device. Further, the UE mobility characteristics controller is configured to determine whether the mobility support indication indicates whether the EEC supports mobility. Further, the UE mobility characteristics controller is configured to subscribe to a 3GPP core network entity for UE location information when the mobility indication indicates that the EEC device supports mobility, store the location information in an EEC context, and send an EEC registration response message to the EEC device. Further, the UE mobility characteristics controller is configured to subscribe to a 3GPP core network entity for UE location analytics information when the mobility indication indicates that the EEC device supports mobility, store the location information in an EEC context, and send an EEC registration response message to the EEC device. Further, the UE mobility characteristics controller is configured to perform one-time location fetch for the EEC when the mobility indication indicates that the EEC device does not support mobility, store the location information in the memory of the EES, and send an EEC registration response message to the EEC device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### Advantageous Effects of Invention

Embodiments of the present disclosure provides methods and apparatus for reducing unnecessary location tracking of the UE base on UE mobility characteristics.

As described above, the disclosure provides a method and apparatus for setting resources of an uplink control channel and an uplink data channel in a 5G communication system, so that a 5G system can be operated more efficiently.

### BRIEF DESCRIPTION OF DRAWINGS

The method and the edge network are illustrated in the accompanying drawings, throughout which like reference letters indicate corresponding parts in the various figures. The embodiments herein will be better understood from the following description with reference to the drawings, in which:

FIG. 1 illustrates an overview of an edge network to share UE mobility characteristics, according to the embodiments as disclosed herein.

FIG. 2 shows various hardware components of an EES to receive UE mobility characteristics in the edge network, according to the embodiments as disclosed herein.

FIG. 3 is a flow chart illustrating a method for sharing the UE mobility characteristics in the edge network, according to the embodiments as disclosed herein.

FIG. 4 is an example sequence diagram illustrating a scenario of EEC registration procedure, according to the embodiments as disclosed herein.

FIG. 5 is an example sequence diagram illustrating a scenario of EEC registration update procedure, according to the embodiments as disclosed herein.

### MODE FOR THE INVENTION

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiment herein is to provide a method to share UE mobility characteristics in an edge network. The method includes receiving, by an EES in the edge network, an EEC registration request message comprising a mobility indication from an EEC device in the edge network. Further, the method includes determining, by the EES, whether the mobility indication indicates whether the EEC device supports mobility. Further, the method includes performing, by the EES, one of: subscribe to a 3GPP core network entity for UE location information and UE location analytics information when the mobility indication indicates that the EEC device supports mobility, storing the location information in a EEC context, and sending a EEC registration response message to the EEC device. Further, the method includes performing one-time location fetch for the EEC when the mobility indication indicates that the EEC device does not support mobility, storing the location information in a memory of the EES, and sending an EEC registration response message to the EEC device.

In an embodiment, the method includes receiving, by the EES, an EEC registration update request message comprising a mobility indication from the EEC device. Further, the method includes determining, by the EES, whether the mobility indication indicates the EEC device supports mobility. Further, the method includes performing, by the EES, subscribe to a 3GPP core network entity for UE location information and UE location analytics information, when the mobility indication indicates that the EEC device supports mobility, storing the location information in the EEC context, and sending an EEC update registration response message to the EEC device. Further, the method includes performing one-time location fetch for the EEC when the mobility indication indicates that the EEC device does not support mobility, storing the location information in the memory of the EES, and sending an EEC update registration response message to the EEC device.

In EDGE APP currently there is no method to determine the mobility characteristics of the UE at Edge Data Network (EDN) unless explicit fetch/subscribe for location is performed. In absence of this mobility characteristics at the EDN, un-necessary and continuous tracking of even UEs with fixed (stationary) mobility behaviour is performed through SUBSCRIBE even for those UEs fixed in particular location (always stay under the same mobile network serving area). Further the same problem exists for any HTTP based applications as HTTP protocol doesn't provide any header or place holder for the UE to reveal its mobility characteristics and obvious problem seen in EDGEAPP that uses HTTP. Unlike to the conventional methods and systems, the proposed method can be used to share “MOBILITY CHARACTERISTICS” of a UE in an edge data network. The mobility characteristics shall be utilized by the EDN to focus more on the UEs with mobile (non-stationary) mobility behaviour, which actually causes handovers demanding smooth Service Continuity and reduce focus on the UEs with fixed mobility behaviour that never goes through handover due to location change. Thus avoiding to perform below subscribe to the UEs with fixed mobility behaviour:
1. Avoid Subscribe to UE Location information: Reducing traffic overhead caused by subscribe mechanism for continuous location reporting, and
2. Avoid Subscribe to UE Location analytics information: Reducing traffic overhead as well as consumption of resources by location analytics (processor, memory etc.) for predicting UEs future location.

The proposed method addresses problem identified as open issue in Key Issue #12: EEL service differentiation as specified in clause 4.12 of 3GPP TR 23.700-98 v1.4.1. The proposed method enables EEC to share its mobility behaviour in EEC registration request information element as defined in table 8.4.2.3.2-1 sent as part of EEC registration and EEC registration update request as per clause 8.4.2.2.2, 8.4.2.2.3 of 3GPP TS 23.558 v 17.3.0.

The method can be used to reduce an overhead caused by a subscribe request in terms of traffic as well as the computing resources that shall be consumed by location analytics. All this is enabled with a simple solution of EEC device (e.g., UE) sharing its mobility information. At same time enabling EES to focus on those UEs which are mobile (non-stationary) and can request for service continuity.

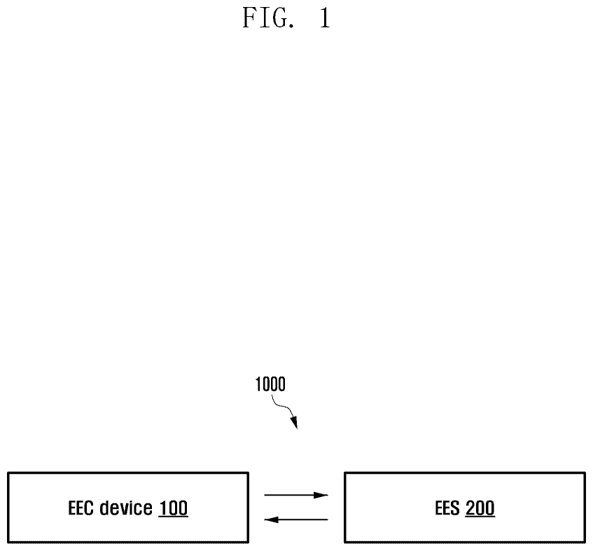

Referring now to the drawings and more particularly to FIGS. 1 through 5, where similar reference characters denote corresponding features consistently throughout the figures, there are shown preferred embodiments.

FIG. 1 illustrates an overview of an edge network (1000) to share UE mobility characteristics, according to the embodiments as disclosed herein. In an embodiment, the edge network (1000) includes an EEC device (100) and an EES (200). The EES (200) receives an EEC registration request message comprising a mobility indication from the EEC device (100). Further, the EES (200) determines whether the mobility indication indicates whether the EEC device (100) supports mobility. In an embodiment, when the mobility indication indicates that the EEC device (100) supports mobility, the EES (200) subscribes to a 3GPP core network entity for UE location information, stores location information in an EEC context, and sends a EEC registration response message to the EEC device (100). In an embodiment, when the mobility indication indicates that the EEC device (100) does not support mobility, the EES (200) performs a one-time location fetch for the EEC device (100) stores the location information in the memory of the EES (200), and sends the EEC registration response message to the EEC device (100).

Further, the EES (200) receives the EEC registration update request message comprising the mobility indication from the EEC device (100). Further, the EES (200) determines whether the mobility indication indicates whether the EEC device (100) supports mobility. In an embodiment, when the mobility indication indicates that the EEC device (100) supports mobility, the EES (200) subscribes to the 3GPP core network entity for UE location information, stores the location information in the EEC context, and sends the EEC update registration response message to the EEC device (100). In another embodiment, when the mobility indication indicates that the EEC device (100) does not support the mobility, the EES (200) performs the one-time location fetch for the EEC device (100), stores the location information in the memory (230) of the EES (200), and sends the EEC update registration response message to the EEC device (100).

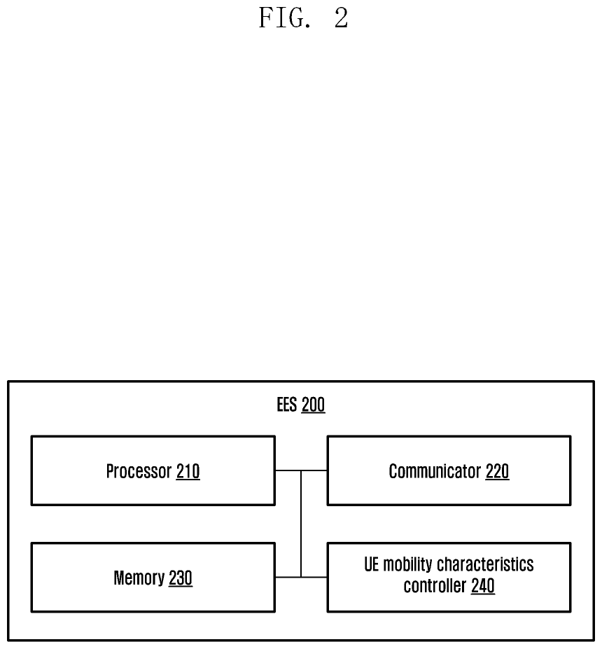

FIG. 2 shows various hardware components of the EES (200) to receive UE mobility characteristics in the edge network (1000), according to the embodiments as disclosed herein. In an embodiment, the EES (200) includes a processor (210), a communicator (220), a memory (230) and a UE mobility characteristics controller (240). The processor (210) is coupled with the communicator (220), the memory (230) and the UE mobility characteristics controller (240).

The UE mobility characteristics controller (240) receives the EEC registration request message comprising the mobility indication from the EEC device (100). Further, the UE mobility characteristics controller (240) determines from the mobility indication whether the EEC device (100) supports mobility. In an embodiment, when the mobility indication indicates that the EEC device (100) supports mobility, the UE mobility characteristics controller (240) subscribes to the 3GPP core network entity for UE location information, stores the location information in the EEC context, and sends an EEC registration response message to the EEC device (100). Further, the UE mobility characteristics controller (240) subscribes to the 3GPP core network entity for UE location analytics information when the mobility indication indicates that the EEC device supports mobility. Further, the UE mobility characteristics controller (240) stores the location information in an EEC context and sends the EEC registration response message to the EEC device. In an embodiment, when the mobility indication indicates that the EEC device (100) does not support mobility, the UE mobility characteristics controller (240) performs the one-time location fetch for the EEC device (100) stores the location information in the memory of the EES (200), and sends the EEC registration response message to the EEC device (100).

Further, the UE mobility characteristics controller (240) receives the EEC registration update request message comprising the mobility indication from the EEC device (100). Further, the UE mobility characteristics controller (240) determines whether the mobility indication indicates whether the EEC device (100) supports mobility. In an embodiment, when the mobility indication indicates that the EEC device (100) supports mobility, the UE mobility characteristics controller (240) subscribes to the 3GPP core network entity for UE location information, stores the location information in the EEC context, and sends the EEC registration update response message to the EEC device (100). Further, the UE mobility characteristics controller (240) subscribes to the 3GPP core network entity for UE location analytics information when the mobility indication indicates that the EEC device supports mobility. Further, the UE mobility characteristics controller (240) stores the location information in the EEC context, and sends the EEC registration update response message to the EEC device. In another embodiment, when the mobility indication indicates that the EEC device (100) does not support the mobility, the UE mobility characteristics controller (240) performs the one-time location fetch for the EEC device (100), stores the location information in the memory (230) of the EES (200), and sends the EEC registration update response message to the EEC device (100).

The UE mobility characteristics controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 2 shows various hardware components of the EES (200) but it is to be understood that other embodiments are not limited thereon. In other embodiments, the EES (200) may include less or more number of components. Further, the labels or names of the components are used only for illustrative purpose and does not limit the scope of the invention. One or more components can be combined together to perform same or substantially similar function in the EES (200).

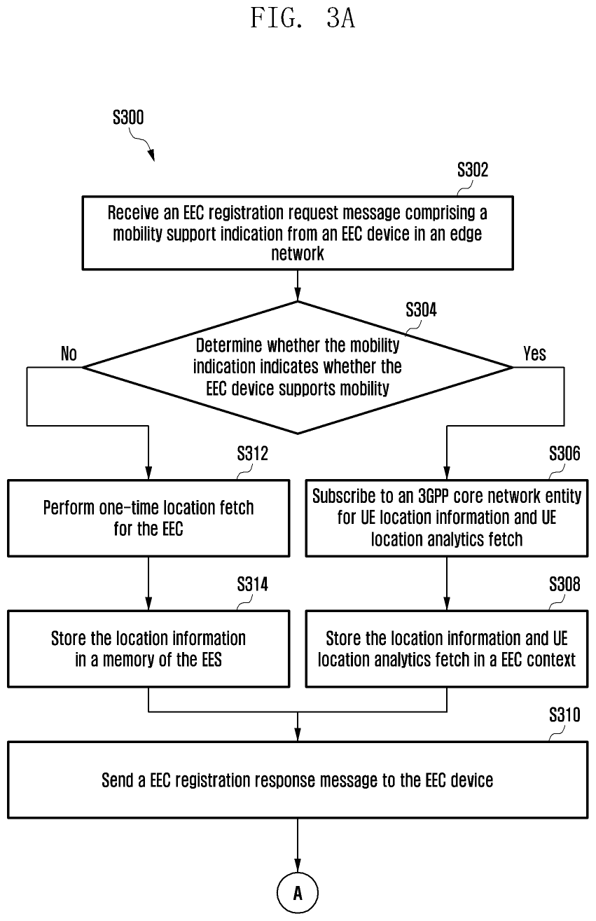

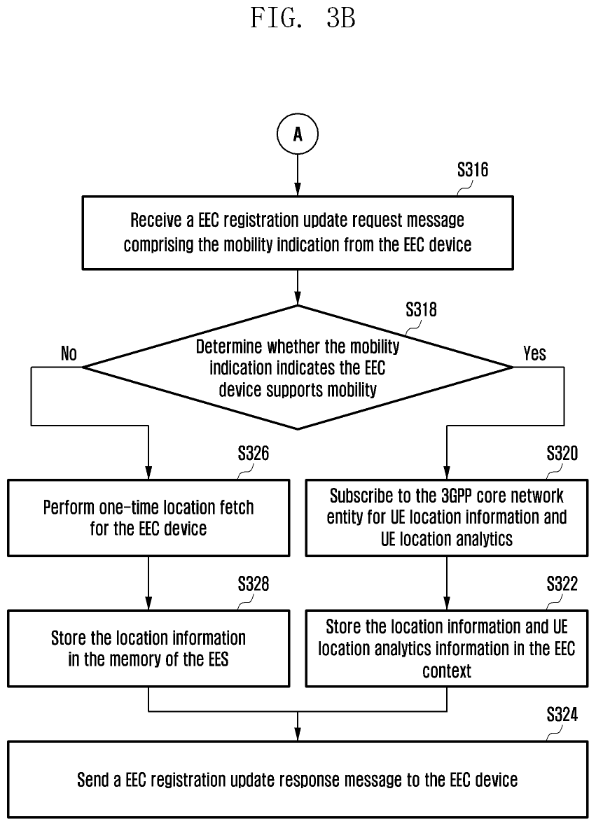

FIG. 3 is a flow chart (S300) illustrating a method for sharing the UE mobility characteristics in the edge network (1000), according to the embodiments as disclosed herein. The operations (S302-S328) are handled by the UE mobility characteristics controller (240).

At S302, the method includes receiving the EEC registration request message comprising the mobility indication from the EEC device (100) in the edge network (1000). At S304, the method includes determining whether the mobility indication indicates whether the EEC device (100) supports mobility. At S306, the method includes subscribing to the 3GPP core network entity for the UE location information and the UE location information analytics when the mobility indication indicates that the EEC device (100) supports mobility. At S308, the method includes storing the location and location analytics information in the EEC context. At S310, the method includes sending the EEC registration response message to the EEC device (100).

At S312, the method includes performing the one-time location fetch for the EEC device (100) when the mobility indication indicates that the EEC device (100) does not support mobility. At S314, the method includes storing the location information in the memory (230) of the EES (200). At S310, the method includes sending the EEC registration response message to the EEC device (100).

At S316, the method includes receiving the EEC registration update request message comprising the mobility indication from the EEC device (100). At S318, the method includes determining whether the mobility indication indicates the EEC device (100) supports mobility. When the mobility indication indicates that the EEC device (100) supports mobility, at S320, the method includes subscribing to the 3GPP core network entity for UE location information and the UE location analytics. At S322, the method includes storing the location and location analytics information in the EEC context. At S324, the method includes sending the EEC registration update response message to the EEC device (100).

When the mobility indication indicates that the EEC device (100) does not support mobility, at S326, the method includes performing one-time location fetch for the EEC device (100). At S328, the method includes storing the location information in the memory of the EES (200). At S324, the method includes sending the EEC registration update response message to the EEC device (100).

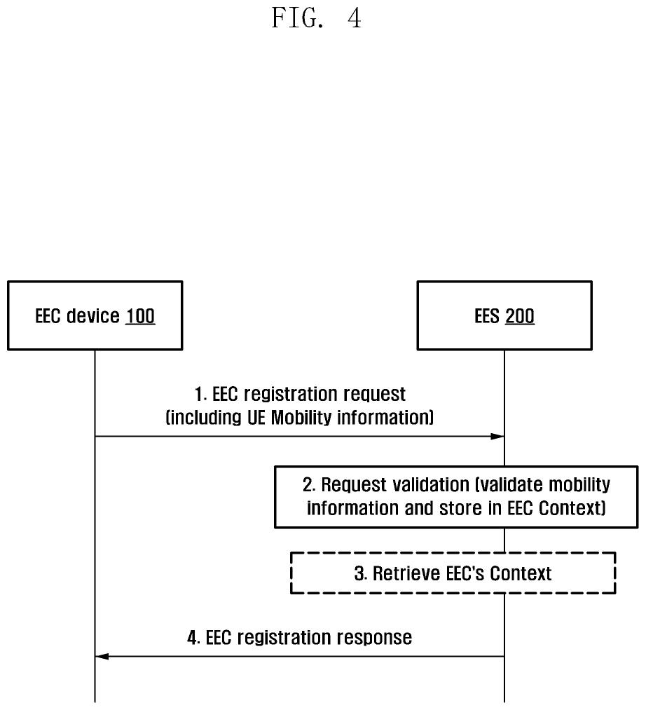

FIG. 4 is an example sequence diagram illustrating a scenario of the EEC registration procedure, according to the embodiments as disclosed herein. The FIG. 4 illustrates the EEC registration procedure. The steps are as follows:

Pre-conditions:

1. The EEC device (100) is authorized to access the EES (200) for the purpose of performing registration and has received relevant security credentials as specified in clause 8.11.

. The EEC device (100) has received service provisioning information from an ECS (not shown), including information for accessing the EES (200).

FIG. 4 is an example sequence diagram illustrating a scenario of the EEC registration procedure (as per FIG. 8.4.2.2.2-1 in clause 8.4.2.2.2 of 3GPP TS 23.558 v 17.3.0) and below procedure:

At step 1, the EEC device (100) sends the EEC registration request to the EES (200). The request from the EEC device (100) includes security credentials received after successful authorization for edge computing services and may include a proposed expiration time. The request also optionally includes information indicating to the EES (200) how the EEC expects to use the services of the EES (200). The request may include mobility information that informs EEC mobility behaviour.
a. If the EEC device (100) is moving to the EES (200) from the purview of another EES, called S-EES (i.e., source EES), the request from the EEC device (100) may include the identity and endpoint of the S-EES and an EEC context ID that was provided by the S-EES to maintain continuity of the EEC context and to authorize EEC context relocation. If the EEC registration is being performed as part of Anonymous Communication Rejection (ACR), the EEC device (100) shall not include the S-EES endpoint and the EEC context ID.

At step 2, upon receiving the request from the EEC device (100), the EES (200) validates the registration request and verifies the security credentials. The EES (200) further determines whether the requirements that were indicated in the AC Profile(s) can be fulfilled and reserves corresponding resources. The EES (200) shall validate the mobility information if shared and store in EEC context for future usage. As part of service continuity the EES (200) shall process the mobility information, in case of:
a. “fixed”, “temporary fixed” mobility: represents the EEC device (100) is stationary, the EES (200) shall perform one-time location fetch for EEC (100) and store in cache. Avoid subscriptions triggered towards Network Exposure Function (NEF), Network Data Analytics Function (NWDEF) for EEC location and its analytics.
b. “mobile”-represents the EEC is non-stationary, the EES (200) shall perform subscriptions triggered towards the NEF, the NWDEF for EEC location and its analytics.
c. In future, the mobility feature proposed here can be used to represent different information related to UE mobility characteristics other than fixed/mobile based on the requirements.

2. Upon successful validation of the request, if the received EEC registration request contains an EEC context ID and an S-EES Endpoint, the EES (200) performs an EEC Context Pull relocation (clause 8.9.2.2) from the S-EES. The source and target EES perform EEC Context handling as detailed in clause 8.9.1.
a. Only a single EEC Context ID may be provided in the EEC registration request.
b. In this version of specification, each registration procedure relocates a single EEC context.
c. Step 3 is executed when EEC determines to change its connection from S-EES to T-EES and ACR is not required.
d. If the EEC registration request fails after the EEC Context Pull relocation, e.g., the EES cannot reserve the necessary resources while meeting the capability requirements of the existing registered EECs, the EES shall determine the EEC Context information stale and send a failure response with a corresponding cause.

At step 3, the EES (200) sends the successful EEC registration response, which includes the registration ID and may include a newly assigned EEC context ID. If step 3 was executed, at step 4, the EEC registration response also includes EEC context retrieval result. The EEC device (100) stores the new EEC context ID and uses it if and when it registers with another EES. The EES may also provide an expiration time to indicate to the EEC when the registration will automatically expire. To maintain the registration, the EEC device (100) shall send a registration update request prior to the expiration. If a registration update request is not received prior to the expiration time, the EES shall treat the EEC as implicitly de-registered.
a. If the EEC context relocation status indicates that the EEC context relocation was not successful, then the EEC performs the required EDGE-1 subscriptions at the T-EES.

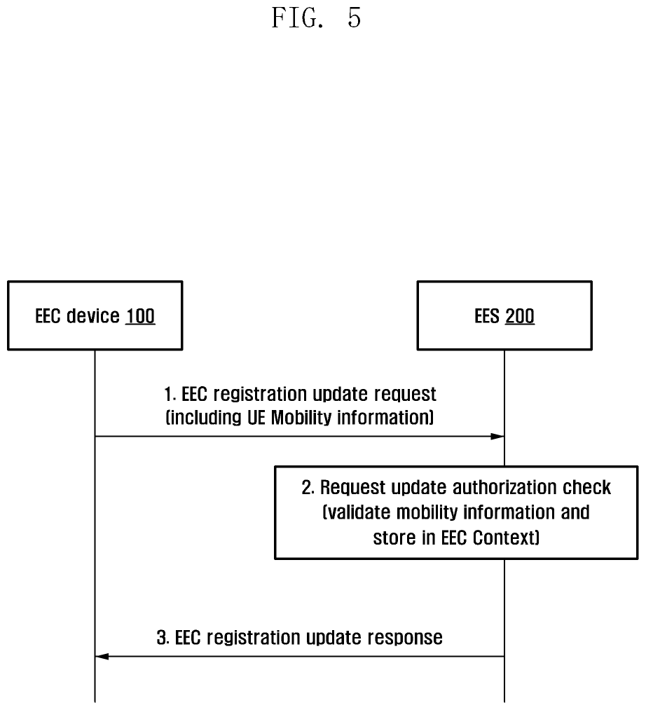

FIG. 5 is an example sequence diagram illustrating a scenario of EEC registration update procedure, according to the embodiments as disclosed herein. The FIG. 5 illustrates the EEC registration update procedure. Pre-conditions are as follows

1. EEC has already registered with the EES.

FIG. 5 illustrates enhancement to EEC registration update procedure (as per FIG. 8.4.2.2.3-1 in clause 8.4.2.2.3 of 3GPP TS 23.558 v 17.3.0) and below procedure:

At step 1, the EEC device (100) sends EEC registration update request to the EES (200). The request from the client includes the security credentials received after successful authorization for edge computing services and may include a proposed expiration time and AC profile(s). The request may include mobility information that informs EEC mobility behaviour.

At step 2, upon receiving the request from the EEC device (100), the EES (200) validates the registration update request and verifies the security credentials. The EES (200) shall validate the mobility information if shared and store in EEC context for future usage. As part of service continuity the EES (200) shall process the mobility information, in case of:

a. “fixed”, “temporary fixed” mobility: represents the EEC is stationary, the EES shall perform one-time location fetch for EEC and store in cache. Avoid subscriptions triggered towards NEF, NWDEF for EEC location and its analytics.

b. “mobile”-represents the EEC is non-stationary, the EES shall perform subscriptions triggered towards NEF, NWDEF for EEC location and its analytics.

At step 3, upon successful validation of the request, the EES (200) ends a successful registration update response, which may include updated expiration time to indicate to the EEC device (100) when the updated registration will automatically expire. To maintain the registration, the EEC device (100) shall send a registration update request prior to the expiration time. If a registration update request is not received prior to the expiration time, the EES 200 ( ) shall treat the EEC as implicitly de-registered.

Considering the proposed method, below Table (1) illustrates the update to EEC registration request.

TABLE 1

| Information element | Status | Description |
|---|---|---|
| EECID | Mandatory (M) | Unique identifier of the EEC. |
| UE Identifier | Optional (O) | The identifier of the hosting UE (i.e. |
| | | GPSI or identity token) |
| Security credentials | M | Security credentials resulting from a |
| | | successful authorization for the edge |
| | | computing service. |
| AC Profile(s) | O | Profiles of ACs for which the EEC |
| | | provides edge enabling services. AC |
| | | Profiles are further described in |
| | | Table 8.2.2-1. |
| EEC Service Continuity | O | Indicates if the EEC supports service |
| Support | | continuity or not. The IE also indicates |
| | | which ACR scenarios are supported by |
| | | the EEC. |
| eecMobility | O | Indicates the EEC mobility |
| | | behaviour(e.g. fixed, temp-fixed, |
| | | mobile) |
| Proposed expiration | O | Proposed expiration time for the |
| time | | registration. |
| EEC context ID | O | Identifier of the EEC context obtained |
| | | from a previous registration. |
| Source EESID | O | Identifier of the EES that provided EEC |
| | | context ID. |
| Source EES Endpoint | O | The endpoint address (e.g. URI, IP |
| | | address) of the EES that provided EEC |
| | | context ID. |

Please note this IE shall not be present when EEC registration is performed as part of ACR.

Table (1) Update to EEC registration request

Please note that to mention the name of the information representing the mobility information of the UE can be changed to different name other than “eecMobility” based on the requirements.

In case of HTTP services, the embodiment proposes new HTTP Header “UE-Props” to solve the problem of mobility and more generic problems that shall be seen in future. Hence the proposed UE-Properties (UE-Props) header is designed in more generic format, where in the header value part shall facilitate to represent different UE characteristics by introducing multiple fields for each. In context of the current invention field name “mobility” is proposed that shall be used to represent the mobility characteristics of the UE. Similarly going ahead, new fields shall be proposed to this header rather than introducing new headers.

In an embodiment, the proposed HTTP header “UE-Props” shall be created and populated with fields to represent the UE properties (characteristics) as defined in below:

Header Name: UE-Props
Compact Form: None
The syntax and semantics of the header field as defined below:
UE-Props = “ UE-Props” “:” #(mobility)
Mobility = (“fixed” | “mobile” | “anystring”) * (ue-props-extn)
ue-props-extn “=” ( token | quoted-string ) ]
The UE-props header field MAY be used to supply the properties of U
E. The header MAY supply an Mobility field to indicate the mobility pr
operties of the UE like fixed(stationary) or mobile(non-stationary). The h
eader MAY also support extensions inline to UE properties for future us
age ex: supply the information like UE is a constraint device as defined
in RFC 7228 clause. 3.

In an example, the proposed UE-Props HTTP Header, UE sharing “fixed” mobility is depicted as below:

PUT /services/org.openmobilealliance.poc-groups/users/sip%3APresUser1%40example.com/group673.xml
HTTP/1.1
Proxy-Connection: Keep-Alive
Host: 107.108.206.21:8080
Content-Type: application/vnd.oma.poc.groups+xml
Content-length: 1123
UE-Props : mobility=”fixed”
User-Agent: SAMSUNG-GT-S6800/1.0 SHP/VPP/R5 NetFront/3.5 Qtv5.3 SMM-MMS/1.2.0 profile/MIDP-2.0
configuration/CLDC-1.1
x-wap-profile: http://wap.samsungmobile.com/uaprof/GT-M8800 3G.rdf

In another example, the proposed UE-Props HTTP Header, UE sharing “mobile” mobility is depicted as below:

PUT /services/org.openmobilealliance.poc-groups/users/sip%3APresUser1%40example.com/group673.xml
HTTP/1.1
Proxy-Connection: Keep-Alive
Host: 107.108.206.21:8080
Content-Type: application/vnd.oma.poc.groups+xml
Content-length: 1123
UE-Props: mobility=”mobile”
User-Agent: SAMSUNG-GT-M8800/1.0SHP/VPP/R5 NetFront/3.5 Qtv5.3 SMM-MMS/1.2.0 profile/MIDP-2.0
configuration/CLDC-1.1
x-wap-profile: http://wap.samsungmobile.com/uaprof/GT-M8800 3G.rdf

In another example, the proposed UE-Props HTTP Header, UE sharing mobile “3D-mobility” is depicted as below:

PUT /services/org.openmobilealliance.poc-groups/users/sip%3APresUser1%40example.com/group673.xml
HTTP/1.1
Proxy-Connection: Keep-Alive
Host: 107.108.206.21:8080
Content-Type: application/vnd.oma.poc.groups+xml
Content-length: 1123
UE-Props : mobility=”mobile; 3D-Motion”
User-Agent: SAMSUNG-GT-M8800/1.0 SHP/VPP/R5 NetFront/3.5 Qtv5.3 SMM-MMS/1.2.0 profile/MIDP-2.0
configuration/CLDC-1.1
x-wap-profile: http://wap.samsungmobile.com/uaprof/GT-M8800 3G.rdf

The various actions, acts, blocks, steps, or the like in the flow charts (S300) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by an edge enabler server (EES) in an edge network, the method comprising:
receiving, from an edge enabler client (EEC) device, an EEC registration request message comprising a first mobility indication, wherein the first mobility indication indicates whether the EEC device supports mobility or not; and
determining whether to subscribe to an 3rd Generation Partnership Project (3GPP) core network entity for at least one of UE location information or UE location analytics information
based on the first mobility indication.

2. The method of claim 1, wherein the method further comprises:
receiving, from the EEC device, an EEC registration update request message comprising a second mobility indication;
determining whether the second mobility indication indicates the EEC device supports mobility;
in case that the second mobility indication indicates that the EEC device supports mobility, subscribing to an 3GPP core network entity for at least one of UE location information and UE location analytics information, storing the location information in an EEC context, and sending a EEC update registration response message to the EEC device; and
in case that the second mobility indication indicates that the EEC device does not support mobility, performing one-time location fetch for the EEC device, storing the location information in memory of the EES, and sending a EEC update registration response message to the EEC device.

3. The method of claim 1,
wherein the first mobility indication indicates at least one of following mobility:
fixed, temporary fixed or mobile.

4. The method of claim 1,
wherein the EEC registration request message further comprises security credentials and a proposed expiration time.

5. An edge enabler server (EES) in an edge network, the EES comprising:
a communicator; and
a controller configured to:
receive, from an edge enabler client (EEC) device, an EEC registration request message comprising a first mobility indication wherein the first mobility indication indicates whether the EEC device supports mobility or not, and
determine whether to subscribe to an 3GPP core network entity for at least one of UE location information or UE location analytics information
based on the first mobility indication.

6. The EES of claim 5, wherein the controller is further configured to:
receive, from the EEC device, an EEC registration update request message comprising a second mobility indication,
determine whether the second mobility indication indicates whether the EEC device supports mobility; and
in case that the second mobility indication indicates that the EEC device supports mobility, subscribe to an 3GPP core network entity for at least one of UE location information and UE location analytics information, store the location information in an EEC context, and send a EEC update registration response message to the EEC device, and
in case that the second mobility indication indicates that the EEC device does not support mobility, perform one-time location fetch for the EEC device, store the location information in memory of the EES, and send a EEC update registration response message to the EEC device.

7. The EES of claim 5,
wherein the first mobility indication indicates at least one of following mobility:
fixed, temporary fixed or mobile.

8. The EES of claim 5,
wherein the EEC registration request message further comprises security credentials and a proposed expiration time.

9. The method of claim 1, further comprising:
determining to perform one time location fetch for the EEC device, in case that the first mobility indication indicates that the EEC device does not support mobility.

10. The EES of claim 5,
wherein the controller is further configured to:
determine to perform one time location fetch for the EEC device, in case that the first mobility indication indicates that the EEC device does not support mobility.
